(19) United States
(12) Patent Application Publication
(10) Pub. No.: US 2004/0073596 A1
(43) Pub. Date: Apr. 15, 2004

(54) Enterprise content delivery network having a central controller for coordinating a set of content servers

(76) Inventors: John Josef Kloninger, Cambridge, MA (US); David M. Shaw, Newton, MA (US)

Correspondence Address: Locke, Liddell & Sapp LLP, c/o David H. Judson, Suite 2200, 2200 Ross Avenue, Dallas, TX, 75201, US

(21) Appl. No.: 10/437,588

(22) Filed: May 14, 2003

Related U.S. Application Data
(60) Provisional application No. 60/380,365, filed on May 14, 2002.

(51) Int. Cl. G06F 15/16

(52) U.S. Cl. 709/200

(57) ABSTRACT

An enterprise content delivery network includes two basic components: a set of content servers, and a central controller for providing coordination and control of the content servers. The central controller coordinates the set of distributed servers into a unified system, for example, by providing provisioning, content control, request mapping, monitoring and reporting. Content requests may be mapped to optimal content servers by DNS-based mapping, or by using a policy engine that takes into consideration such factors as the location of a requesting client machine, the content being requested, asynchronous data from periodic measurements of an enterprise network and state of the streaming media servers, and given capacity reservations on the enterprise links. An ECDN provisioned with the basic components facilitates various customer applications, such as one or more of the following: live, corporate, streaming media (internal and Internet sources) and HTTP content delivery.

This application is based on and claims priority from pending Provisional Application Serial No. 60/380,365, filed May 14, 2002.

### BACKGROUND OF THE INVENTION

Enterprise network usage behind the firewall is growing significantly, as enterprises take advantage of new technologies, such as interactive streaming and e-learning applications, which provide a return on investment (ROI). Solutions that can allow enterprises to increase their network usage without a directly proportional increase in necessary bandwidth (Enterprise Content Delivery Solutions/Networks) will be required for enterprises to achieve the ROI they expect from these technologies. Primary drivers for the ECDN requirement include, among others: streaming webcasts that can be used for internal communications, streaming e-learning applications for more cost-effective corporate training, and large file downloads that are bandwidth intensive, yet necessary for collaboration projects (manuals, blueprints, presentations, etc).

Enterprises are evaluating many of these solutions because they offer a higher value at a lower cost than the methods they are currently using. For instance, internal streaming webcasts allow for improved communication with employees with the benefits of schedule flexibility (thanks to the ability to create a VOD archive), reach (by eliminating physical logistics such as fixed-capacity meeting rooms and distance barriers), and attendance tracking (thanks to audience reporting capabilities) all without expenses such as travel, accommodations, rented facilities, or even expensive alternatives such as private satellite TV. However, the networks that are in place in these enterprises are generally not built to the scale that is required by these applications. The majority of corporate networks are currently built with fairly low capacity dedicated links to remote offices (Frame Relay, ATM, T1, and the like) and these links are generally right-sized, in that they are currently used to capacity with day to day mission critical applications such as email, data transfer and branch office internet access (via the corporate HQ). Delivering a streaming-and-slide corporate presentation from a corporate headquarters to, say, forty-five remote offices, each connected by a 256 k or 512 k frame relay, and each having 10-100 employees, is simply not possible without some type of overlay technology to increase the efficiency of bandwidth use on the network.

It would be desirable to be able to provide an ECDN solution designed to be deployed strategically within a corporate network and that enables rich media delivery to end users where existing network connections would not be sufficient.

### BRIEF SUMMARY OF THE INVENTION

It is an object of the present invention to provide an ECDN wherein a central controller is used to coordinate a set of distributed servers (e.g., caching appliances, streaming servers, or machines that provide both HTTP and streaming media delivery) in a unified system.

It is a further object of the invention to provide a central point of control for an ECDN to facilitate unified provisioning, content control, request mapping, monitoring and reporting.

An enterprise content delivery network ECDN preferably includes two basic components: a set of content servers, and at least one central controller for providing coordination and control of the content servers. The central controller coordinates the set of distributed servers into a unified system, e.g., by providing provisioning, content control, request mapping, monitoring and reporting. Content requests may be mapped to optimal content servers by DNS-based or HTTP redirect-based mapping, or by using a policy engine that takes into consideration such factors as the location of a requesting client machine, the content being requested, asynchronous data from periodic measurements of an enterprise network and state of the servers, and given capacity reservations on the enterprise links. An ECDN provisioned with the basic components facilitates various customer applications, such as live, corporate, streaming media (from internal or Internet sources), and HTTP Web content delivery.

In an illustrative ECDN, DNS-based or HTTP-redirect-based mapping is used for Web content delivery, whereas metafile-based mapping is used for streaming delivery. Policies can be used in either case to influence the mapping.

The present invention also enables an enterprise to monitor and manage its ECDN on its own, either with CDNSP-supplied software, or via SNMP extensibility into the Company's own existing enterprise management solutions.

The present invention further provides for bandwidth protection—as corporations rely on their connectivity between offices for mission critical day to day operations such as email, data transfer, salesforce automation (SFA), and the like. Thus, this bandwidth must be protected to insure that these functions can operate. Unlike on the Internet, where an optimal solution is to always find a way to deliver requested content to a user (assuming the user is authorized to retrieve the content), on the intranet, the correct decision may be to explicitly deny a content request if fulfilling that request would interrupt the data flow of an operation deemed to be more important. The present invention addresses this need with the development of an application-layer bandwidth protection feature that enables network administrators to define the maximum bandwidth consumption of the ECDN.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram of an illustration enterprise content delivery network implementation;

FIG. 1A is a block diagram of an illustrative Central Controller of the present invention;

FIG. 2 is an illustrative ECDN content flow wherein a given object is provided to an ECDN content server and made available to a set of requesting end users;

FIG. 3 is another illustrative ECDN content flow where a Central Controller uses a policy engine to identify an optimal Content Server and the Content Server implements a bandwidth protection;

FIG. 4 illustrates an alternative mapping technique for streaming-only content requests using a metafile;

FIG. 5 illustrates how redirect mapping may be used in the ECDN;

FIG. 6 illustrates live streaming in an ECDN wherein two or more Content Servers pull a single copy of a stream to make the stream available for local client distribution;

FIG. 7 illustrates multicast streaming in the ECDN;

FIG. 8 is a representative interface illustrating a monitoring function;

FIG. 9 is a representative interface illustrating real-time usage statistics from use of the ECDN;

FIG. 10 illustrates a representative Policy Engine of a Central Controller; and

FIG. 11 illustrates a custom metafile generated for a particular end user in an ECDN.

### DETAILED DESCRIPTION OF THE PREFERRED EMBODIMENT

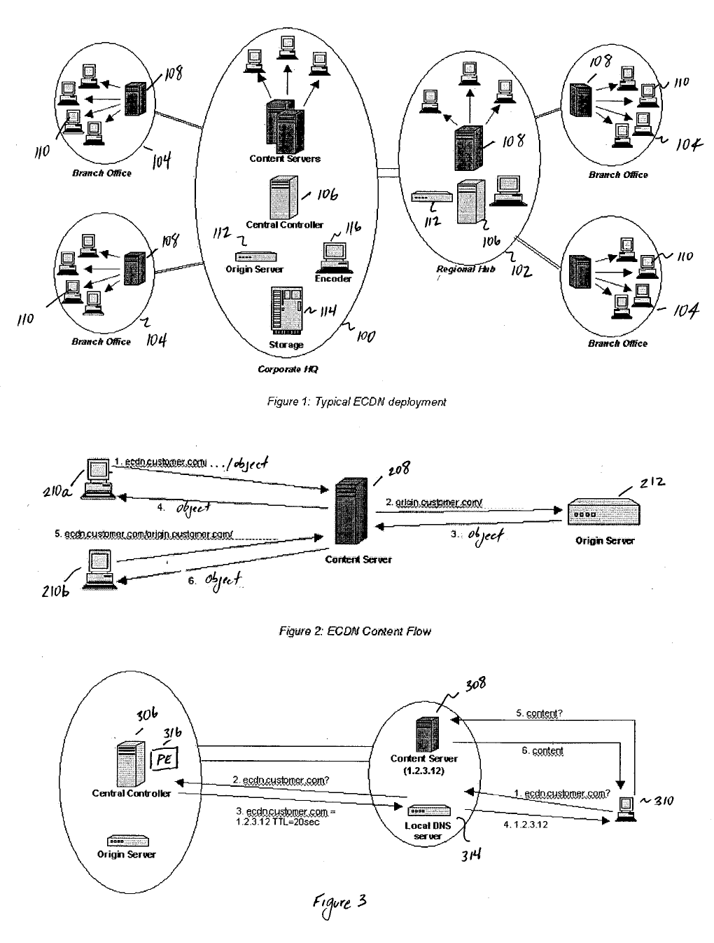

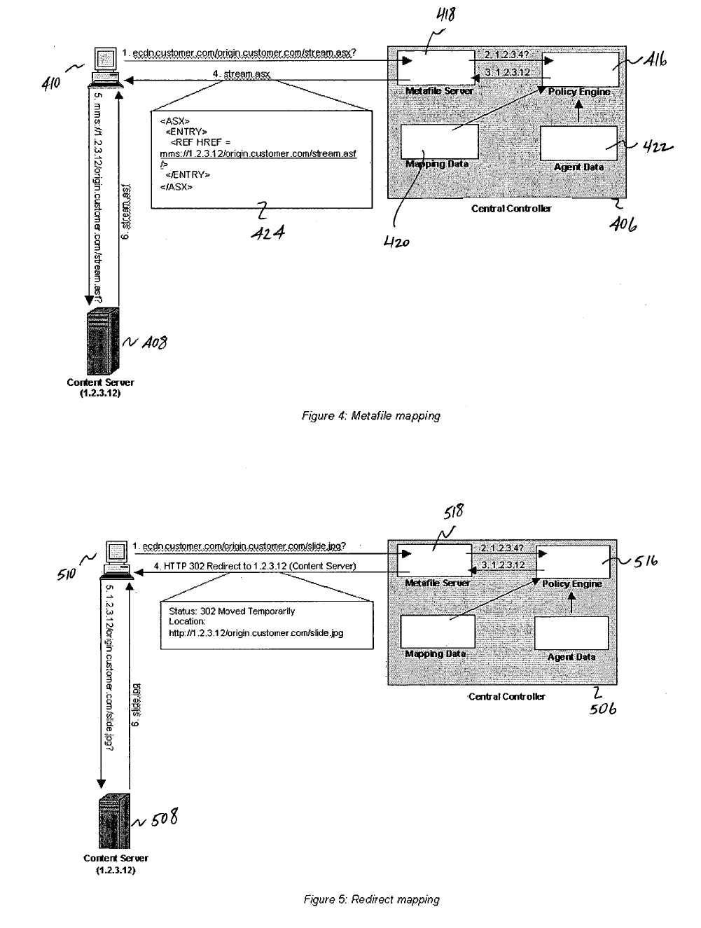

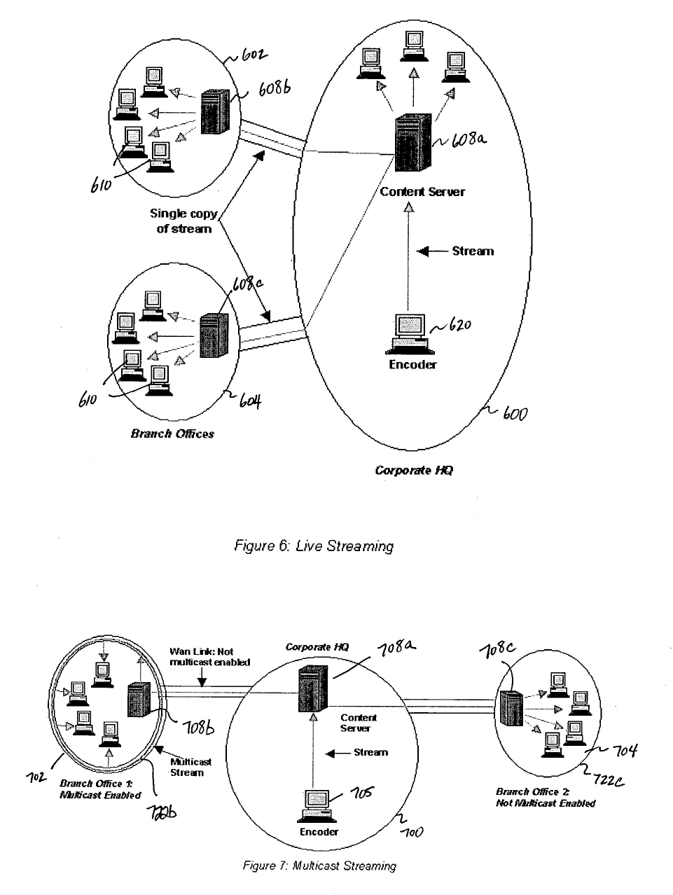

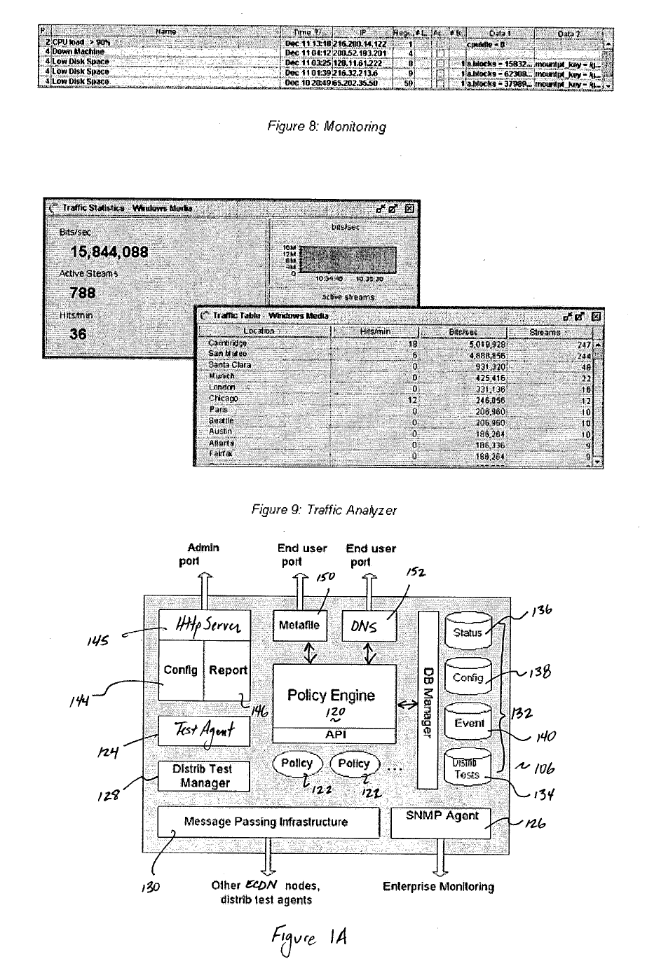

As best seen in FIG. 1, an illustrative ECDN solution of the present invention is preferably comprised of two types of servers: Central Controllers 106 and Content Servers 108. In this illustrative example, there is a corporate headquarters facility 100, at least one regional hub 102, and a set of one or more branch offices 104. This layout is merely for discussion purposes, and it is not meant to limit the present invention, or its operating environment. Generally, a Central Controller 106 coordinates a set of distributed Content Servers and, in particular, provides a central point of control of such servers. This facilitates unified provisioning, content control, request-to-server mapping, monitoring, data aggregation, and reporting. More specifically, a given Central Controller 106 typically performs map generation, testing agent data collection, real-time data aggregation, usage logs collection, as well as providing a content management interface to functions such as content purge (removal of given content from content servers) and pre-warm (placement of given content at content servers before that content is requested). Although not meant to be limiting, in a typical ECDN customer environment Central Controllers are few (e.g., approximately 2 per 25 edge locations), and they are usually deployed to larger offices serving as network hubs. Content Servers 108 are responsible for delivering content to end users, by first attempting to serve out of cache, and in the instance of a cache miss, by fetching the original file from an origin server. A Content Server 108 may also perform stream splitting in a live streaming situation, allowing for scalable distribution of live streams. As illustrated in FIG. 1, Content Servers are deployed as widely as possible for maximum Intranet penetration. FIG. 1 also illustrates a plurality of end user machines 110.

Other components that complement the ECDN include origin servers 112, storage 114, and streaming encoders 116. The first two are components that most corporate networks already possess, and the latter is a component that is provided as a part of most third party streaming applications.

FIG. 1A illustrates a representative Central Controller 106 in more detail. A Central Controller preferably has a number of processes, and several of these processes are used to facilitate communications between the Central Controller and other such controllers (if any are used) in the ECDN, between the Central Controller and the Content Servers, and between the Central Controller and requesting end user machines. As seen in FIG. 1A, a representative Central Controller 106 includes a policy engine 120 that may be used to influence decisions about where and/or how to direct a client based on one or more policies 122. The policy engine typically needs information about the network, link health, http connectivity and/or stream quality to influence mapping decisions. To this end, the Central Controller 106 includes a measuring agent 124, which comprises monitoring software. The measuring agent 124 performs one or more tests and provides the policy engine 120 with the information it may need to make a decision. In an illustrative embodiment, the agent 124 is used to check various metrics as defined in a suite of one or more tests. Thus, for example, the measuring agent may perform ping tests to determine whether other ECDN machines around the network are alive and network connections to them are intact. It provides a general test of connectivity and link health. It may also perform http downloads from given servers, which may be useful in determining the general health of the server providing the download. It may also provide RTSP and WMS streaming tests, which are useful in determining overall stream quality, bandwidth available for streaming, encoder statistics, rendering quality and the like. Such information is useful to help the policy engine make appropriate decisions for directing clients to the right streaming server. The agent may also perform DNS tests if DNS is being used to map clients to servers. The agent 124 preferably provides the policy engine scheduled and synchronous, real-time results. Preferably, the agent is configured dynamically, e.g., to support real-time tests, or to configure parameters of existing tests. The agent preferably runs a suite of tests (or a subset of the supported tests) at scheduled intervals. It monitors the resources it uses and preferably adjusts the number of tests as resources become scarce. The agent 124 may include a listener process that listens on a given port for new test configuration files that need to be run synchronously or otherwise. The listener process may have its own queue and worker threads to run the new tests.

The agent 124 may include an SNMP module 126 to gather link performance data from other enterprise infrastructure such as switches and routers. This module may be implemented conveniently as a library of functions and an API that can be used to get information from the various devices in the network. In a representative embodiment, the SNMP module 126 includes a daemon that listens on a port for SNMP requests.

The Central Controller 106 preferably also includes a distributed test manager 128. This manager is useful to facilitate real-time streaming tests to determine if there are any problems in the network or the stream before and during a live event. As will be described, the distributed test manager 128 cooperates with a set of test agents that are preferably installed on various client machines or content servers across the network and report back (to the distributed test manager) test results. The manager 128 is configurable by the user through configuration files or other means, and preferably the manager 128 provides real-time reports and logging information. The manager 128 interfaces to its measuring agents and to other distributed test manager processes (in other Central Controllers, if any) through a communications infrastructure 130. This interface enables multiple managers 128 (i.e., those running across multiple Central Controllers) to identify a particular Central Controller that will be responsible for receiving and publishing test statistics.

Generally, the communications infrastructure is also used to communicate inter-process as well as inter-node throughout the ECDN. Although not a requirement, preferably the infrastructure is implemented as a library that can be linked into any process that needs communications. In an illustrative embodiment, the infrastructure may be based on a group communications toolkit or other suitable mechanism. The communications infrastructure enables the controller to be integrated with other controllers, and with the content servers, into a unified system.

The tool 128 facilitates synchronous real-time streaming tests. In operation, a user supplies a configuration file to each of the Central Controllers around the enterprise. This configuration file may specify a URL to test, specify which machines will run the tests, and specify how many tests to run and for how long.

As also seen in FIG. 1A, the Central Controller 106 preferably includes a database 132 to store agent measurements 134, internal monitoring measurements 136, configuration files 138, and general application logging 140. This may be implemented as a single database, or as multiple databases for different purposes. A database manager 142 manages the database in a conventional manner.

The Central Controller 106 preferably also includes a configuration GUI 144 that allows the user to configure the machine. This GUI may be a Web-based form that allows the user to input given information such as IP address/netmask, network layout (e.g., hub and spoke, good path out, etc.), and capacity of various links. Alternatively, this information is imported from other systems that monitor enterprise infrastructure.

The Central Controller 106 preferably also includes a reporting module 146 that provides a Web-based interface, and that provides an API to allow additional reports to be added as needed. The reporting module preferably provides real-time and historical report and graph generation, and preferably logs the information reported by each Central Controller component. The reporting module may also provide real-time access to recent data, summary reports, and replay of event monitoring data. In an illustrative embodiment, the module provide data on performance and status of the Central Controller (e.g., provided to the enterprise NOC over SNMP), network health statistics published by the measuring agent and representing the Central Controller's view of the network (which data may include, for example, link health, server health, bandwidth available, status of routers and caches, etc.), network traffic statistics that comes from the policy engine, Content Servers, and other devices such as stream splitters (which data may include, for example, number of bits being served, number of concurrent users, etc), and information about decision making in the Central Controller that comes from the policy engine (which data may include, for example, a report per client showing all the streams requested by the client, and per stream showing all the clients requesting the stream and where they were directed), data for managing and monitoring a live event, stream quality measurements, and the like.

Communications to and from the configuration and reporting modules may occur through an http server 145.

The policy engine 120 collects pieces of information from the various testers and other Central Controllers. The policy engine 120 uses the data collected on the state of the network and the Central Controller, as well as optionally the network configuration data, the distributed tool test data, and the like (as may be stored in the database), and rules on the policy decisions that are passed to it. As illustrated in FIG. 1A, the policy engine may influence decisions whether routing is provided by a metafile redirector 150, or by a DNS name server 152. Preferably, the policy engine 120 is rules-based, and each rule may be tried in rank order until a match is made. The user may have a collection of canned frequently used rules and/or custom rules. As an example, the policy engine may include simple rules such as: bandwidth limitation (do not use more than n bandwidth), liveness (do not send clients to a down server), netblock (consider client location in determining where to send a client), etc. Of course, these rules are merely illustrative.

The metafile redirector 150 accepts hits from streaming clients, requests a policy ruling from the policy engine 120, and returns this policy decision to the client, either in a metafile or a redirect. This will be illustrated in more detail below.

Alternatively, the Central Controller may implement DNS-based mapping of client requests to servers. In this case, the DNS name server 152 accepts hits from HTTP clients, requests a policy ruling from the policy engine 120, and returns this policy decision to the client, typically in the form of an IP address of a given content server.

Generally, metafile mapping is used for mapping requesting clients to streaming media servers, whereas DNS or redirect-based mapping is used for mapping requesting clients to http content servers.

Although not meant to be limiting, the Central Controller may be implemented on an Intel-based Linux (or other OS) platform with a sufficiently large amount of memory and disk storage.

### Content Flow

As noted above, there are preferably several ways in which content flows are accomplished. As a first example, consider basic HTTP object delivery. In this representative example as seen in FIG. 2, there is a Central Controller (not shown) and a content server 208. When content is requested, the request is directed, preferably via the DNS in the Central Controller, in this case to the best content server 208 able to answer the request. If the content that is being requested is in the cache of the content server, the file is served to the user. If the file is not in cache, it is retrieved from the origin and simultaneously cached for future requesters.

In particular, end user machine 210a has requested an object by selecting a given URL. A given URL portion, such as ecdn.customer.com, is resolved through DNS to identify an IP address of the content server 208. Thus, the Central Controller (not shown) conveniently provides authoritative DNS for the ECDN. At step (1), the end user browser then makes a request for the object to the content server 208. In this example, it is assumed that the content server 208 does not have the object. Thus, at step (2), content server 208 makes a request to the origin server 212, and the location of the origin server 212 can be found by resolving origin.customer.com through DNS if necessary. At step (3), the object is returned to the content server 208, cached, and, at step (4), the object is made available for the requesting end user machine 210a, as well as another end user machine 210b that might also request the object. These are steps (5)-(6).

A similar technique may be implemented for HTTP-based progressive downloads of a stream. In this case, the workflow is similar, but instead of a file being cached, the content server pulls the stream from its origin and distributes it to users. Preferably, files are retrieved progressively using HTTP 1.1 byte range GETS, so the content server 208 can begin to serve the end user 210 before the file has been completely transferred.

### Mapping

To direct an end user client machine to the optimal server, several pieces of information are required. As noted above, the Central Controller may use DNS-based mapping to route requests. DNS-based mapping, however, typically is not used if the enterprise does not have caching name servers adequately deployed throughout the network, or for streaming-only content requests.

As illustrated above, DNS requests are enabled by delegating a zone to the ECDN (e.g., ecdn.customer.com) with the Central Controller(s) being the authoritative name servers. Content requests then follow traditional DNS recursion until they reach the Central Controller. If the client has local recursive name servers, the local DNS uses the Central Controllers as authoritative name servers. Upon receiving the DNS request, the Central Controller returns the WP address of the optimal content server for the request, preferably based on known network topology information, agent data collected on server availability and performance, and network-based policy to the client's name server, or to the client, in the absence of a local name server. Content is then requested from the optimal content server. Because these DNS responses factor in changing network conditions, their TTLs preferably are short. In a representative embodiment, the TTL on a response from the Central Controller preferably is 20 seconds.

### Bandwidth Protection

A primary IT concern when using rich media applications on the intranet is ensuring that these applications do not swamp network links and disrupt mission-critical applications such as email, salesforce automation (SFA), database replication, and the like. The bandwidth protection feature of ECDN allows network administrators to control the total amount of bandwidth that the ECDN will utilize on any given network link. In a simple embodiment, at the time of a content request, the Content Server to which the user is mapped makes a determination as to whether that request can be fulfilled based on the settings that have been determined by the network administrator. Several pieces of information preferably make up this determination. Is the requested object currently in cache or in the case of a live stream, is the stream already going into the Content Server? If the content is not in cache, does enough free bandwidth as defined by the network administrator exist on the upstream link to fetch the content? If the content is in cache, or if enough upstream bandwidth is available to fetch the content, does enough free bandwidth exist on the downstream link to serve the content? If all of these criteria are true, the content will be served.

This operation is illustrated in FIG. 3. In this example, the client machine 310 makes a DNS request to resolve ecdn.customer.com (again, which is merely representative) to its local DNS server 314. This is step (1). The local DNS server 314 makes the request to the Central Controller 306, which has been made authoritative for the ecdn.customer.com domain. This is step (2). The Central Controller 306 policy engine 316 consults network topology information, testing agent data and any other defined policies (or any one of the above), and, at step (3), returns to the local DNS server 314 an IP address (e.g., 1.2.3.12) of the optimal content server 308, preferably with a given time-to-live (TTL) of 20 seconds. At step (4), the local DNS server 314 returns to the requesting client machine 310 the IP address of the optimal Content Server 308. At step (5), the client requests the desired content from the Content Server 308. At step (6), the Content Server 308 checks against the bandwidth protection criteria (e.g., is the content in cache, is the upstream bandwidth acceptable, is the downstream bandwidth acceptable, and so forth?) and serves the content to the client. This completes the processing.

In the example of FIG. 3, the bandwidth protection is implemented in the Content Server. This is not a limtation. Alternatively, bandwidth protection is implemented in a distributed manner. If bandwidth protection is done in a distributed manner, the ECDN Central Controller may maintain a database of link topology and usage, and that database is frequently updated, to facilitate the bandwidth protection via a given policy. Alternatively, bandwidth protection can be implemented by the Central Controller heuristically.

### Metafile Mapping

While DNS-based mapping is advantageous for HTTP object delivery (and delivery of progressive downloads), streaming media delivery is preferably accomplished using metafile-based mapping. Metafiles may also be used where the enterprise does not have caching name servers adequately deployed. Metafile based mapping is illustrated in FIG. 4.

In this method, preferably all requests for content are directed through the Central Controller 406, which includes the Policy Engine 416, a Metafile Server 418, Mapping Data 420, and Agent Data 422. A link to a virtual metafile is published, and when the client requests this file, the request is sent to the Central Controller. The Central Controller then uses the request to determine the location of the client, runs the request information through the Policy Engine 416, and automatically generates and returns a metafile pointing the customer to the optimal server. The metafile preferably is generated by a Metafile Server 418. For instance, the Policy Engine 416 could determine that a request cannot be fulfilled due to bandwidth constraints, but rather than simply denying the request, it could return a metafile for a lower bitrate version of the content, or, should the velvet rope feature become invoked, an alternative “please come back later” clip could be served. Because streaming content generally has a longer delay due to buffering, the additional delay for metafile mapping is almost imperceptible.

As illustrated in FIG. 4, in metafile-based mapping the end user machine 410 requests the content by selecting a link that includes given information, which is this example is ecdn.customer.com/origin.customer.com/stream.asx? This is step (1). The request is directed to the Central Controller 406, which, after consulting the Policy Engine (steps (2)-(3)) generates (at step (4)) the metafile 424 (in this example, stream.asx) pointing the customer to the optimal server through the new link, via the illustrative URL mms://1.2.3.12/origin.customer.comnstream.asf/. At step (5), the end user machine navigates directly to the Content Server 408 (at the identified IP address 1.2.3.12) and requests the content, which is returned at step (6).

### Redirect Mapping

For large files such as the slides that accompany a streaming presentation, software application distribution, or large documents or presentations, redirect based mapping provides significant benefits by distributing these larger files via the content servers, thus reducing the amount of bandwidth required to serve all end users. Redirect mapping may also be used where the enterprise does not have a local DNS, or the local DNS does not provide sufficient flexibility.

This process is illustrated in FIG. 5. Like metafile mapping, redirect mapping directs all requests for content to the Central Controller. Upon receiving the request for content, the client's IP address is run through the Policy Engine, which determines the optimal Content Server to deliver the content. An HTTP 302 redirect is returned to the client directing them to the optimal content server, from which the content is requested.

This process is illustrated in FIG. 5. In this example, the end user machine 510 makes a request for a given object, at ecdn/customer/com/origin.customer.com/slide.jpg? This is step (1). At steps (2)-(3), the Central Controller 506. Metafile Server 518 consults the Policy Engine 516 and identifies an IP address (e.g., 1.2.3.12) of an optimal Content Server 508. At step (4), an HTTP redirect is issued to the requesting end user machine. At step (5), the end user client machine issues a request directly to the Content Server 508, using the IP address provided. The content is then returned to the client machine at step (6) to complete the process.

### Live Streaming

Live streaming, from the delivery standpoint, is quite similar to on-demand streaming or object delivery in many respects. The same questions need to be answered to direct users to the appropriate content servers: which is the best content server (based on both user and server data)? Is the data being requested already available on this server or does it need to be retrieved from its origin? If it needs to be retrieved, can that be accomplished within the limitations of the upstream link (bandwidth protection)?

Because an encoded stream is not a file, it cannot be cached. But, the encoded stream can still be distributed, for example, via stream splitting. Using the ECDN, a live stream can be injected into any content server on the network. Other content servers can then pull the stream from that server and distribute it locally to clients, thus limiting the bandwidth on each link to one copy of the stream. This process is illustrated in FIG. 6. In particular, corporate headquarters 600 runs an encoder 620 that provides a stream to the Content Server 608a. This single copy of the stream is then pulled into branch offices 602 and 604 by the Content Servers 608b and 608c respectively, for delivery to the local clients 610.

From a workflow perspective, the only difference is that the content creator must notify the network of the stream for distribution to take place. The stream is then pulled into the Content Server 608a and is available to users via the other Content Servers (e.g., servers 608b and 608c) in the network.

### Multicast Streaming

The ECDN solution supports both multicast and unicast live streaming. By distributing content servers within the intranet, one of the major hurdles to using multicast is removed—getting the stream across a segment that is not multicast-enabled. As illustrated in FIG. 7, there is a given office 700, and a pair of branch offices 702 and 704. In this example, branch office 702 is multicast-enabled, whereas branch office 704 is not. Office 700 includes an encoder 705 that generates a stream and provides the stream to a Content Server 708a. Content Servers 708b and 708c pull one copy of the stream into the LAN 722b and 722c, ensuring that the stream reaches the content server intact. From there, inside the multicast-enabled LAN 722b, multicast publishing points are created and users are able to view the multicast stream. In LAN 722c, where there is no multicast, delivery takes place as already described. Thus, as illustrated here, the same stream can be distributed to a hybrid intranet (i.e. some LANs are multicast-enabled, others such as 722b are not), and the decision to serve multicast or unicast preferably is made locally and dynamically.

Thus, while LAN multicast is commonplace in an enterprise, enabling true-multicast across all WAN links is a difficult proposition. The present invention addresses this problem by enabling unicast distribution over WAN links to stream splitters that can provide the stream to local multicast-enabled LANs. This enables the streaming event to be provided across the enterprise to LANs that support multicast, and LANs that do not. Preferably, the Central Controller makes this determination using a policy, e.g. unicast to office A (where the LAN is not multicast-enabled), and multicast to office B (where multicast is enabled).

### Content Management

As noted above, content creators need to be able to publish and control content on the ECDN platform. Additionally, any third party application that relies on the ECDN for delivery needs to be able to have access to content management functions, giving users access to such functions from within its application interface.

The ECDN offering allows content creators to control the content they deliver via the system. Content control features include:

Publish—direct users to fetch content via the ECDN Content Servers, thus utilizing the ECDN for content delivery. Publishing content to the ECDN is a simple process of tagging the URL to the content to direct requests to the Content Servers.

Provision—direct the ECDN to begin pulling a live stream from an encoder into a specified Content Server to be distributed within the network

Pre-warm—actively pre-populate some or all Content Servers with specified content, to ensure it is served from cache when it is requested. This is useful when a given piece of content is expected to be popular, and can even be schedule to take place at a time when network usage is known to be light.

Purge—remove content from some or all Content Servers so that it can no longer be accessed from the cache in the Content Server.

TTL/Version Data—Instruct Content Servers when to refresh content into the cache when it is requested to ensure content freshness. This enables content creators to keep a consistent file naming structure while ensuring the correct version of the content is served to clients.

The Central Controller preferably provides a user interface to content management functions on the system. In the illustrative Controller of FIG. 1A, content management is facilitated through the administrative interface, the data is stored in the database, and then pushed out through the message passing infrastructure.

However, in some cases, third party applications may be used to create and manage content. Thus, the ECDN solution preferably includes an API for third party application vendors to use to call these functions of the ECDN from within their application interface.

### System Management

### Monitoring/Management

Preferably, the ECDN comprises servers and software deployed into an enterprise's network, behind the enterprise firewall, with limited or no access by a CDN service provider (CDNSP) or other entity unless it is granted, e.g., for customer support troubleshooting. Thus, preferably the ECDN is managed and monitored by the customer's IT professionals in their Network Operations Control Center (NOCC).

All components of the ECDN preferably publish SNMP MIBs (Management Information Base) to report their status. This allows them to be visible and managed via commercial enterprise management solutions, such as HP Openview, CA Unicenter, and Tivoli (which are merely representatives. IT staff who use these solutions to monitor and manage other network components can therefore monitor the ECDN from an interface with which they are already accustomed to and comfortable with.

The ECDN may provide monitoring software to provide information on the network including machine status, software status, load information and many alerts of various degrees of importance. This monitoring software may be used on its own, or in conjunction with a customer's enterprise management solution, to monitor and manage the ECDN. FIG. 8 illustrates a representative monitoring screen showing the status of various machines in the ECDN.

The ECDN may also include a tool for network administrators to use to ensure that the ECDN is performing as expected. A Distributed Test Tool may be provided to allow IT staff to deploy software to selected clients in remote locations and run tests against the clients, measuring availability and performance data from the clients' perspectives. The data is then presented to the administrator, confirming the delivery through the ECDN. This tool is especially useful prior to large internal events, to ensure that all components are functioning completely and are ready for the event.

### Reporting

Usage data is available to network administrators from the ECDN. Data can be captured both in real-time as well as historically. Usage data can be useful for several reasons, including measuring the success of a webcast in terms of how many employees viewed the content and for how long, and determining how much bandwidth events are consuming and where the velvet rope network protection feature has been used often, to better plan infrastructure growth.

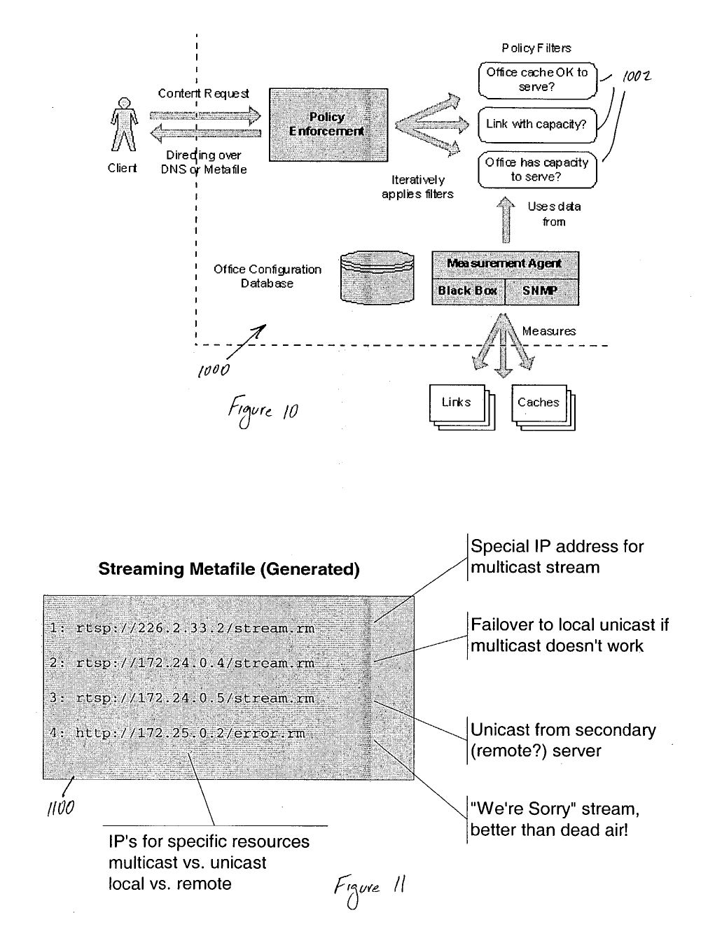

Real time reporting information can be viewed in a graphical display tool such as illustrated in FIG. 9. This tool may display real-time usage statistics from the ECDN, and it can display total bandwidth load, hits per second and simultaneous streams, by network location (individual branch offices) or in aggregate.

Although not meant to be limiting, usage logs preferably are collected from each Content Server and are aggregated in the Central Controllers. These logs may then be available for usage analysis. All logs may be maintained in their native formats to permit easy integration with third party monitoring tools designed to derive reports from server logs. Usage logs are useful to provide historical analysis as well as usage data on individual pieces of content.

An ECDN as described herein facilitates various customer applications, such as one or more of the following: live, corporate, streaming media (internal and Internet sources), HTTP content delivery, liveness checking of streaming media servers, network “hotspot” detection with policy-based avoidance and alternative routing options for improved user request handling, video-on-demand (VOD) policy management for the distribution of on-demand video files, intranet content distribution and caching, and load management and distributed resource routing for targeted object servers.

As noted above, preferably the ECDN includes a tool that can be brought up on browsers across the company to do a distributed test. The tool is provided with configuration from a Central Controller that will tell the tool what test stream to pull, and for how long. The tool will then behave like a normal user: requesting a host resolution over DNS, getting a metafile, and then pulling the stream. The tool will report back its status to the Central Controller, reporting failure modes like server timeouts, re-buffering events, and the like.

The following are illustrative components for the distributed testing tool:

A form-based interface on the Central Controller to enable a test administrator to configure a test. Preferably, the administrator tests an already-provisioned event, in which case DNS names could be generated automatically to best simulate the event (all-hands.ecdn.company.com gets converted to all-hands-test.ecdn.company.com). This is not a requirement, however.

The tool served up by from Central Controller, preferably in the form of a browser-based applet. When an administrator opens up the application, he or she is prompted for the URL for the test event, e.g. http://all-hands-test.ecdn.company.com/300 k_stream.asx.

It is the responsibility of the test coordinator to place a test stream in a known location behind a media server.

The applet may be pre-configured to know the location of the Central Controller where it should report test status.

The Central Controller may generate a real-time report showing the test progress, and once the test is complete, show a results summary.

Although an applet is a convenient way to implement the tool, this should not be taken to limit the invention, as a test application may be simply integrated with the streaming players. Another alternative is to embed this capability into the Content Server machines.

A desirable feature of the ECDN Central Controller is its ability to satisfy requests in keeping with user-specified policies. FIG. 10 shows an end-user making a request for content to the Central Controller 1000, the policy being enforced by iterative application of one or more policy filters 1002, and the request being served. The policy filters themselves preferably are programmed to an API so they can be customized for particular customer needs. Via this API the filters may make their decisions on many factors, including one or more of the following:

the office of the requester, based on IP and office CIDR block static configuration,

the content being requested,

asynchronous data from periodic measurements of the network, cache health, and the like,

synchronous measurements for particular cache contents (despite resulting latency), and

capacity reservations for this and other upcoming events.

Based on these factors, which are merely representative, a filter may choose to serve the content requested by directing the user to an appropriate cache or stream splitter, serve them an alternative metafile with a “we're sorry” stream, or direct the user to a lower-bandwidth stream if available. The filter model is an extensible and flexible way to examine and modify a request before serving.

The following are additional details concerning metafile generation and routing. All streaming formats rely on metafiles for describing the content that the streaming media player should render. They contain URLs describing the protocols and locations the player can use for a stream, failing over from one to the next until it is successful. In an illustrative embodiment, there may simply be two choices. The player will first try to fetch the stream using UDP-based RTSP, and if that fails, will fallback to TCP-based HTTP. Instead of serving stock metafiles, a more robust implementation of the Central Controller changes the metafiles on the fly to implement decisions. In this alternative embodiment, each client may get a made-to-order metafile, such as illustrated in FIG. 11. Thus, for example, the Central Controller may generate metafiles based on the IP address of the requester, the content that is being requested, and current network conditions, all based on pre-configured policy. In the example in FIG. 11, the metafile 1100 is generated for an office where multicast has been set up. The IP address beginning with “226” is for a multicast stream; in fact, any IP address between 224.0.0.0 and 239.255.255.255 is reserved to be for multicast sessions. In this example, this number has been reserved for this streaming event, and it is only given once the administrator knows that multicast is working and the stream splitter in that office is alive and well. This example also demonstrates the power of metafile fail-over.

The Central Controller may also integrate and make information and alerts available to existing enterprise monitoring systems. Appropriate monitoring tasks should be assigned to all devices in the system. Collected information from any device should be delivered to the Central Controller for processing and report generation. Preferably, ECDN monitoring information and alerts should be available at the console of the Central Controller nodes, and by browser from a remote workstation.

The Content Server preferably is a multi-protocol server supporting both HTTP delivery, and streaming delivery via one or more streaming protocols. Thus, a representative Content Server includes an HTTP proxy cache that caches and serves web content, and a streaming media server (e.g., a WMS, Real Media, or Apple Quicktime server). Preferably, the Content Server also includes a local monitoring agent that monitors and reports hits and bytes served, a system monitoring agent that monitors the health of the local machine and the network to which it is connected, as well as other agents, e.g., a data collection agents that facilitate the aggregation of load and health data across a set of content servers. Such data can be provided to the Central Controller to facilitate unifying the Content Server into an integrated ECDN managed by the Central Controller. A given Content Server may support only HTTP delivery, or streaming media delivery, or both.

An ECDN may comprise existing enterprise content and/or media servers together with the (add-on) Central Controller, or the ECDN provider may provide both the Central Controller and the content servers. As noted above, a Content Server may be a server that supports either HTTP content delivery or streaming media delivery, or that provides both HTTP and streaming delivery from the same machine.

Having described our invention, what we claim is as follows.

1. A controller for use in an enterprise environment, in conjunction with a set of content servers, comprising:
first code executable in a processor to perform a given suite of tests selected from a set of tests that include a test for liveness of a given content server, a test for existence of a given communication link to a given content server, a test regarding health of a given content server, a test on quality of a given data stream deliverable from a given content server, and a test regarding a given state of the controller;
a database for storing configuration data, and data generated from the given suite of tests; and
second code executable in the processor for using data in the database to associate client requests to the set of content servers according to a given policy;
third code executable in the processor to provide a given suite of reports selected from a set of reports that include performance and status of the controller, network health statistics, network traffic statistics, and routing decisions;
fourth code executable in the processor to configure the given suite of tests and the given suite of reports; and
communications infrastructure to integrate into a unified enterprise network the controller and the given set of content servers.

2. The controller as described in claim 1 further including fifth code executable in the processor to provide a given content management control function selected from a set of functions that include provisioning content for delivery from the set of content servers, pre-populating content to the set of content servers, purging content from the set of content servers, and providing content freshness data to the set of content servers.

3. The controller as described in claim 1 wherein the second code implements a policy engine that associates a given client request with a given one of the set of content servers according to the given policy.

4. The controller as described in claim 3 wherein second code includes a metafile server that provides the association via a metafile.

5. The controller as described in claim 3 wherein the second code includes a name server that provides a DNS-based mapping of a given client request to a given content server.

6. The controller as described in claim 1 wherein the second code executable in a processor includes a metafile generator, and a policy engine, wherein a given request for content is executed against the policy engine to identify a given content server, and the metafile generator generates a metafile that include data identifying the given content server.

7. The controller as described in claim 6 wherein the policy engine includes code for determining whether the given request can be fulfilled due to bandwidth constraints, and wherein the metafile generator includes code responsive to the determination for generating a metafile identifying a lower bitrate version of the content.

8. The controller as described in claim 1 wherein the first code includes a test tool for identifying a test stream, for retrieving and rendering the test stream, and for reporting status data.

9. A content delivery system for use in an enterprise behind an enterprise firewall, comprising:
a set of content servers; and
a controller; comprising:
first code executable in a processor to perform a given suite of tests;
a database for storing configuration data, and data generated from the given suite of tests;
second code executable in the processor for using data in the database to associate client requests to the set of content servers according to a given policy; and
communications infrastructure to integrate into a unified enterprise network the controller and the set of content servers.

10. The content delivery system as described in claim 9 wherein a given content server provides HTTP object delivery, streaming media delivery, or both HTTP object delivery and streaming delivery.

11. The content delivery system as described in claim 10 wherein the given content server includes a first agent that monitors content served from the content server, a second agent that monitors the health of the content server and a network to which the server is connected, and a third agent that aggregates and reports to the controller load and health data to facilitate integration of the content server into the unified enterprise network..

12. The content delivery system as described in claim 9 wherein the controller further includes:
third code executable in the processor to provide a given suite of reports; and
fourth code executable in the processor to configure the given suite of tests and the given suite of reports.

13. A content delivery system for use in an enterprise behind a firewall, comprising:
a controller located at a first location and comprising code executable in a processor to provide a policy-based content server selection function based on a given criteria selected from a set of criteria including: location of a requesting client machine, content being requested, asynchronous data from periodic measurements of an enterprise network and state of given content servers, and a given capacity reservation; and
a set of content servers, wherein a given content server is located at a second, location remote from the first location and delivers content to a requesting end user machine that has been mapped to the content server by the controller.

14. The content delivery system as described in claim 13 wherein the set of content servers includes a subset of servers located on a network that supports multicasting.
